(19) United States
(12) Patent Application Publication
(10) Pub. No.: US 2021/0355388 A1
(43) Pub. Date: Nov. 18, 2021

(54) PROCESS FOR REMOVING CATALYST FINES BY NANOFILTRATION

(71) Applicant: SHELL OIL COMPANY, HOUSTON, TX (US)

(72) Inventors: Johannes Pieter HAAN, Amsterdam (NL); Aldo CAIAZZO, Amsterdam (NL); Johannes Leendert Willem Cornelis DEN BOESTERT, Amsterdam (NL)

(21) Appl. No.: 17/281,958

(22) PCT Filed: Sep. 26, 2019
(86) PCT No.: PCT/EP2019/075998

§ 371 Date: Mar. 31, 2021

Related U.S. Application Data
(60) Provisional application No. 62/739,372, filed on Oct. 1, 2018.

(51) Int. Cl. C10G 31/09; B01D 61/02

(52) U.S. Cl. CPC C10G 31/09; C10G 11/18; B01D 61/027

(57) ABSTRACT

The present invention provides a process for removing catalyst fine particles from a hydrocarbon product, the process including providing at least one nanofiltration membrane to remove the catalyst fine particles from the hydrocarbon product, the catalyst fine particles comprising a particle size of 0.1 microns or less, contacting the hydrocarbon product at a feed side of the nanofiltration membrane, recovering a catalyst fines-depleted stream at a permeate side of the nanofiltration membrane, recovering a catalyst fines-enriched stream at a retentate side of the nanofiltration membrane, and wherein the catalyst fines-enriched stream comprises the catalyst fine particles removed from the hydrocarbon product, the catalyst fine particles comprising a particle size of 0.1 microns or less.

### CROSS-REFERENCE TO RELATED APPLICATIONS

This non-provisional application claims the benefit of Appl. Ser. No. 62/739,372, filed Oct. 1, 2018, the disclosure of which is incorporated herein by reference.

### FIELD OF INVENTION

The present invention is directed to a process for removing catalyst fines comprising aluminum and silicon containing particles of 0.1 microns or less from a hydrocarbon product.

### BACKGROUND

Fluid catalytic cracking (FCC) is an established chemical conversion process carried out in a FCC unit comprising at least one FCC reactor, fractionator, and regenerator, among additional ancillary equipment. The FCC process uses catalysts to convert long-chained hydrocarbon molecules derived from crude oils into shorter-chained molecules of a higher value. Feedstock used during FCC can include high-boiling, high-molecular weight hydrocarbon fractions of petroleum crude oils, often mixed with refinery residues. The feedstock is heated and brought into contact with a heated catalyst comprising particles consisting of aluminum and silicon (Al+Si). The Al+Si particles can be in the form of beads or pellets and are of such a size that when fluidized or “fluffed-up” with heated air or hydrocarbon vapors behave like a fluid to freely move through process equipment.

During FCC, the Al+Si particles break apart, or crack, long-chained molecules into shorter-chained molecules, which are collected as a vapor effluent in the reactor section of the FCC unit. The vapor effluent passes from the reactor section to least one main fractionator or distillation column to be separated into desired FCC fractions. The FCC fractions are categorized based on boiling points and into several intermediate products, including gases (e.g., ethene, propene, butene, LPG), gasoline, light gas oil, heavy gas oil, and FCC slurry oil, among others.

A regenerator recovers and regenerates the used Al+Si particles, or spent Al+Si particles, eroded during the FCC process for further use. However, unrecovered spent Al+Si particles are inevitably carry over into the main fractionator and, thus, into some of the various FCC fractions, such as the FCC slurry oil. The spent Al+Si particles are of a finely, divided abrasive form and are known as catalyst fines.

Although the fractionated FCC slurry oil comprises an Al+Si particle content, it is a highly aromatic fluid with a low viscosity of about 30 to 60 cSt at 50° C., a high density of about 1,000 kg/m³ at 15° C., and a low sulfur content, as compared to other heavy residual oils. It is therefore often used as a preferred feedstock or as a heavy fuel oil blending component. Yet, it is well-known that the Al+Si content contained therein reduces the value and use of the FCC slurry oil. For instance, using a catalyst fines-enriched FCC slurry oil can produce a fuel product with an undesirable catalyst fines content and inferior qualities. In fact, generally-accepted fuel quality standards restrict the Al+Si content in fuel oils to an Al+Si particles content of 60 ppm or less. In the marine industry, engine manufacturers stipulate a 15 ppm Al+Si particles content as the maximum acceptable level of catalyst fines at fuel injection point. Accordingly, use of a catalyst fines-enriched FCC slurry oil can potentially lead to premature machinery and/or equipment damage and failure when used as a fuel source, for example, in combustion engines. Accordingly, the FCC slurry oil should be further processed and clarified to remove its Al+Si content, thus, maximizing its potential value before its continued use.

U.S. Pat. No. 4,919,792 describes a method for clarifying slurry oil withdrawn from a fractionator downstream of a catalytic cracking unit. According to this method, a settling reagent is added to the slurry oil. Thereafter, the settling reagent and catalyst fines are separated from the slurry oil by physical means to recover a clarified slurry oil product. The settling reagent used in the method can include any material that promotes settling of catalyst fines from heavy, aromatic hydrocarbons at high temperatures.

U.S. Pat. No. 8,932,452 describes a method for removing catalyst, catalyst fines, and coke particulates from a slurry oil stream generated during a FCC processes. According to this method, hydrocyclone vessels are used to create a spin and centrifugal force to move catalysts, catalyst fines, and coke particulates entrained in the FCC slurry oil toward internal walls of the hydrocyclone and to direct a clean slurry oil inward towards a central longitudinal axis of the hydrocyclone. The hydrocyclones are located in a FCC slurry oil loop situated between the main column of the FCC fractionator and various downstream equipment and storage vessels.

U.S. Pat. No. 7,332,073 describes removing filterable particulates and unfilterable aluminum-containing contaminants larger than 1 micron in diameter from a feed stream. The filterable particulates are removed from the feed stream by a first product filter to generate a filtered stream, which still contains a significant amount of unfilterable aluminum-containing contaminant particles smaller than 1 micron in diameter. The generated filtered stream is sent to a guard-bed reactor where the aluminum-containing contaminant particles smaller than 1 micron are coalesced to form particles having a size greater than about 1 micron. A second product filter removes the aluminum-containing particles having a size greater than about 1 micron to yield a purified wax feed stream containing less than 5 ppm aluminum as elemental metal.

Conventional approaches, including membrane filtration, sedimentation, electrostatic precipitation, and centrifuge technologies may remove catalyst fines with a particle diameter of 1 micron (μm) or larger from a FCC-generated slurry oil. For example, membrane filter separation techniques such as ultrafiltration and microfiltration have long been used for contaminant removal during hydrocarbon production, environmental clean-up, wastewater treatment, and water purification, among others. Some of the disadvantages of ultrafiltration membranes include membrane fouling, i.e., membrane pores clogging or plugging, and membrane swelling so that separation efficiency, permeability, and selectivity of the filtration process are hampered. Microfiltration membranes are sensitive to oxidative chemicals such as nitric acid, sulfuric acid, etc. and are prone to fouling effects which can lead to a decrease in permeate flux. Moreover, ultrafiltration membranes include an average pore size greater than 0.1 μm and microfiltration membranes include an average pore size ranging from 0.1 to 10 μm. Thus, both membranes may be useful for only removing particles sizes within those ranges.

Based on the present state of the art, none of the aforementioned technologies are proven to remove catalyst fines at a sub-micron size, for example, smaller than 0.1 μm. In particular, due to a relatively high surface area to weight ratio, such technologies do not effectively remove catalyst fines smaller than 0.1 μm, more specifically catalyst fines smaller than 0.01 μm, and most specifically catalyst fines smaller than 0.001 μm from a hydrocarbon product.

In view of the present state of the art, there is a continuing need for a membrane filtration process that removes catalyst fines smaller than 0.1 μm from a hydrocarbon product at reasonable flux and permeability values to yield filtered hydrocarbon products comprising low Al+Si contents.

### SUMMARY OF THE INVENTION

According to one embodiment of the invention, a process for removing catalyst fine particles from a hydrocarbon product includes providing at least one nanofiltration membrane to remove the catalyst fine particles from the hydrocarbon product, the catalyst fine particles comprising a particle size of 0.1 microns or less, contacting the hydrocarbon product at a feed side of the nanofiltration membrane, recovering a catalyst fines-depleted stream at a permeate side of the nanofiltration membrane, recovering a catalyst fines-enriched stream at a retentate side of the nanofiltration membrane, and where the catalyst fines-enriched stream comprises the catalyst fine particles removed from the hydrocarbon product, the catalyst fine particles comprising a particle size of 0.1 microns or less.

According to another embodiment of the invention, a membrane separation unit for use in a catalytic cracking unit includes at least one nanofiltration membrane to remove catalyst fine particles from a hydrocarbon product, the catalyst fine particles comprising a particle size of 0.1 microns or less, a feed side of the nanofiltration membrane for contacting the hydrocarbon product, a permeate side of the nanofiltration membrane for recovering a catalyst fines-depleted stream, a retentate side of the nanofiltration membrane for recovering a catalyst fines-enriched stream, and wherein the catalyst fines-enriched stream comprises the catalyst fine particles removed from the hydrocarbon product, the catalyst fine particles comprising a particle size of 0.1 microns or less.

### DESCRIPTION OF THE DRAWINGS

Certain exemplary embodiments are described in the following detailed description and in reference to the drawings, in which:

FIG. 1 is a schematic block diagram of an embodiment of a nanofiltration membrane process in a FCC unit for removing catalyst fine particles from a hydrocarbon product; and

FIG. 2 is a schematic block diagram of an embodiment of a nanofiltration membrane process in a FCC unit for removing catalyst fine particles from a hydrocarbon product and further including a nanofiltration membrane backwashing process.

### DETAILED DESCRIPTION

It is therefore an object of the present intention to upgrade a FCC slurry oil by removing and reducing the total amount of catalyst fine particles comprising a particle size of 0.1 μm or less contained therein. This object is achieved by the inventive nanofiltration process that uses at least one nanofiltration membrane to remove and reduce the total amount of catalyst fine particles of 0.1 μm or less. Another object of the present invention is to provide a membrane separation unit for use during a nanofiltration process that removes and reduces the total amount of catalyst fine particles of 0.1 μm or less. This object is achieved by the inventive nanofiltration separation unit that comprises at least one nanofiltration membrane to remove catalyst fine particles of 0.1 μm or less. The at least one nanofiltration membrane of the present invention is a non-porous (i.e., no pores) membrane or a porous membrane comprising pores having an average size of at most 50 nm to remove catalyst fines particles of 0.1 μm or less contained within a FCC slurry oil.

The production of a FCC slurry oil during a FCC process leaves behind residues of particulate matter usually comprised of aluminum and silicon (Al+Si) particles called catalyst fines, in addition to other contaminants (i.e., sediment, water) found within the oil. Catalyst fines are hard in nature and range in size from several microns down to sub-microns, which makes removal from the FCC slurry oil by conventional techniques, such as settling tanks, hydrocyclones, or centrifuges, difficult or even impossible.

Nanofiltration is a pressure-driven separation process where nanofiltration membranes act as a selective barrier to separate and restrict the passage of contaminant particles smaller than 0.1 μm which are dissolved in the feed. In particular, the pressure differential, or the trans-membrane pressure (TMP), of the feed over the nanofiltration membrane is the driving force that enhances transport through the membrane to separate and remove the particles contained therein.

Suitable nanofiltration membranes have a molecular weight cut off (MWCO) of 2,000 Daltons (Da) or less, preferably 1,000 Da or less, and more preferably 500 Da or less. Nanofiltration membranes can be produced in various forms such as plate and frame, spiral wound, tubular, capillary and hollow fiber formats and from a range of materials, such as polymeric materials (e.g., cellulose derivatives and synthetic polymers), inorganic materials (e.g., ceramics or glass), and from organic/inorganic hybrids. Accordingly, separation and removal of the particles may depend on the differences in solubility and diffusivity for non-porous polymeric (i.e., dense) nanofiltration membranes or molecular size exclusion for ceramic (i.e., porous) nanofiltration membranes.

Typical nanofiltration separation processes include three flow streams including a feed that is separated into a permeate (or filtered product) and a retentate (or concentrate). In the present embodiments, separation of the feed includes initially flowing the feed into a feed side of polymeric or ceramic nanofiltration membranes. The feed can include a liquid hydrocarbon product, such as FCC slurry oil or clarified FCC slurry oil, that is composed of liquids, catalyst fines, and other contaminated particulate matter. The concentration of catalyst fines in the feed may be at least 30 parts per million weight (ppmw) of Al+Si containing particles ranging in size from sub-microns up to 1 μm.

The liquid that passes along and is filtered by the nanofiltration membrane comprises the permeate and is recovered at a permeate side of the membrane. The permeate is considered as a catalyst fines-depleted stream since the concentration of catalyst fines contained therein is less than 10 ppmw, preferably less than 1 ppmw, and more preferably, the permeate contains a non-measurable amount of catalyst fines.

The liquid rejected from passing along the nanofiltration membrane includes solutes of the original feed which form a concentrated stream, or retentate. The retentate is recovered at a retentate side of the nanofiltration membrane and can be either recycled or disposed of as waste. The retentate is considered as a catalyst fines-enriched stream since it includes a portion of the feed that was not filtered by the nanofiltration membrane and thus, comprises a sufficient catalyst fines particle concentration.

Applicants have surprisingly found that the nanofiltration process and membrane unit of the present embodiments provide a reliable and stable method for producing quality end-products by removing Al+Si containing particles smaller than 0.1 μm from a feed FCC slurry oil. Specifically, nanofiltration membranes filter the FCC slurry oil by removing Al+Si containing particles smaller than 0.1 μm, preferably smaller than 0.01 μm, more preferably smaller than 0.001 μm to provide a filtered product, or permeate. The permeate, or the catalyst fines-depleted stream of the present invention, that is recovered at the permeate side of the nanofiltration membrane comprises a reduced Al+Si particles content, or most preferably a non-measurable amount of Al+Si particles, as compared to the original feed. Accordingly, the nanofiltration process and membrane unit of the present embodiments effectively produces at least a 50% permeate yield, i.e., the fraction of feed that is filtered or recovered as permeate. The permeate, or catalyst fines-depleted stream, contains a reduced concentration of Al+Si particles of 0.1 μm or less as opposed to conventional approaches which fail to remove particles of this size. Thus, another advantage of the nanofiltration process and membrane unit of the present embodiments includes providing a permeate that contains 10 ppmw or less, 1 ppmw or less, or a non-measurable amount of the Al+Si containing particles of 0.1 μm or less.

The retentate, or catalyst fines-enriched stream, of the present invention that is recovered at the retentate side of the nanofiltration membrane comprises an increased concentration of Al+Si particles since it contains the particles of 0.1 μm or less that were removed from the FCC slurry oil feed during nanofiltration. The benefits the Applicants have surprisingly found from using nanofiltration to remove an Al+Si content from FCC slurry oil include increased permeate yields, improved filtered product market value due to low Al+Si contents, and reduced wear and tear of process equipment, in addition to, improved catalyst recovery and handling processes.

As a further advantage, Applicants have surprisingly found that use of polymeric nanofiltration membranes and/or ceramic nanofiltration membranes provide for such exemplary results during removal of Al+Si particles of 0.1 μm or less from the FCC slurry oil. For example, less fouling of the nanofiltration membrane occurs, at reasonable flux values, as opposed to use of other membrane technologies, such as ultrafiltration or microfiltration. In this way, nanofiltration membranes are taken out of operation on a less frequent basis so that the present process can be performed on a more continuous basis.

A FCC unit may comprise one or more FCC reactors where a hydrocarbon feedstock (e.g., heavy gas oil, vacuum gas oil, vacuum residue) reacts with hot, finely-divided, solid catalyst particles previously heated in a regenerator. The FCC cracking reaction is carried out in the FCC reactor where the catalyst cracks the feedstock at high temperatures to generate a reactor effluent. Typical reactors in a FCC unit operate at about 340 to 600° C. and at relatively low pressures of 0.5 to 1.5 bars. The FCC unit also includes regenerators and separators, among other equipment. It should be noted that the inventive process can be also carried out during residual fluid catalytic cracking (RFCC), deep catalytic cracking (DCC), or any other catalytic cracking process where removal of Al+Si containing particles smaller than 0.1 μm is desired.

Suitable catalysts used in the FCC cracking reaction increase product yields under much less severe operating conditions, for example, than in thermal cracking conditions. Such catalysts can include a mixture of functional components with suitable cracking properties such as zeolites, matrices, additives, fillers, and binders that further consist of aluminum oxide (i.e., alumina) and silicon oxide (i.e., silica) particles. Zeolites provide higher activity and selectivity to increase cracking capacity and product yields. An active matrix, such as alumina, contributes to the overall performance of the catalyst by providing the primary cracking sites. Additives may include, for example, components for trapping contaminant metals (e.g., nitrogen and vanadium) and carbon monoxide (CO) combustion promoters for catalyst regeneration. The filler (e.g., clay) is incorporated into the catalyst to dilute its activity and the binder serves as a glue to hold the zeolite, matrix, and filler together. The binder may or may not have catalytic activity and is preferably composed of silica or silica-alumina.

For the desired reactions to occur, catalyst particles used in the FCC unit often consist of fine powders with a bulk density of 0.80 to 1.0 g/cm³ and a particle size distribution ranging from about 10 to 300 μm, usually about 100 μm. Overall, the FCC catalyst comprises a number of characteristics to meet the demands of the FCC unit including high activity, selectivity, and stability in high temperatures. Additionally, the catalyst should embody adequate fluidization properties, resistance attrition, coke selectivity, and metal tolerance, among other catalyst parameters. In the preferred embodiments, the preferred catalyst is an inorganic oxide support comprising an alumina-silica particle mixture comprising from about 10 to 40 wt % alumina. However, the composition of the catalyst particles may vary depending on the feedstock and the desired end products.

After carrying out FCC cracking reactions, a reactor effluent is produced and exits the top of the FCC reactor to flow into a bottom section of a separation zone, including one or more distillation columns, but more commonly referred to as the main fractionator of the FCC unit. The main fractionator separates the reactor effluent into various lighter hydrocarbon products, i.e., FCC products, including FCC slurry oil, heavy cycle oil, light cycle oil, butane, propane, among others.

The FCC slurry oil recovered from the main fractionator is as a heavy residual oil bottom product where at least 80 wt %, more preferably at least 90 wt %, boils at or above 425° C. and may comprise about 4 to 12 wt % of the total products separated by the main fractionator. FCC slurry oil typically comprises various impurities such as sulfur ranging from 0.3 to 5.0 wt %, nitrogen ranging from 0.1 to 3.0 wt %, nickel+vanadium (Ni+V) ranging from 0-200 ppmw, and carbon residue ranging from 5 to 17 wt %. Overall, the FCC slurry oil quality is a function of various variables, including properties of the FCC feed, severity of operations, catalyst types, and operating conditions of the FCC unit.

The FCC slurry oil also contains residual Al+Si catalyst fines that are of a much smaller size than the catalysts initially introduced into the FCC unit. Catalyst fines can vary in physical size, from sub-microns up to 75 μm, and are continuously created in the FCC unit when larger catalyst particles are eroded due to particle-to-particle collision or particle collision with the internal surface of the reactor. Catalyst fines are often not captured by cyclones located near the reactors since cyclone removal efficiency reduces with decreasing particle size. As such, catalyst fines carry over to the main fractionator with the reactor effluent and exit the fractionator as a component contained within a FCC product, for example, the FCC slurry oil.

Part of the catalyst fines-containing FCC slurry oil can be recycled back to the main fractionator with the remainder being either further processed or used as-is for end-product. However, due to its appreciable catalyst fines content, the FCC slurry oil is often further processed by existing clarifying techniques such as sedimentation, filtration, centrifugation, or the like. The clarifying techniques may remove a portion of the entrained catalyst fines, thus, producing a FCC clarified slurry oil. However, even after clarification, the FCC clarified slurry oil may still contain a catalyst fines content ranging in size from sub-microns up to 10 μm. The catalyst fines can also include undesirable impurities such as potassium, sodium, carbon and various metals (e.g., copper, iron, nickel, vanadium).

As described herein, a FCC catalyst fines containing slurry oil (“FCC cat fines slurry oil”) of the present embodiments includes either the FCC clarified slurry oil or the FCC slurry oil. The Al+Si particles in the FCC cat fines slurry oil comprise an average particle size diameter ranging from 0 to 25 μm in a concentration that can vary widely from at least 30 ppmw up to 2,000 ppmw. As described herein, the Al+Si particle concentration describes the mass ratio between the catalyst fines and the FCC cat fines slurry oil using the unit, parts per million weight (ppmw).

In many cases, industry specifications and standards prohibit further use of the FCC cat fines slurry oil due its catalyst fines content which can affect end-product quality, in addition, to causing machinery and/or equipment damage and failure. Thus, in accordance with the present invention, a membrane filtration process comprising nanofiltration technology is implemented to remove Al+Si containing particles smaller than 0.1 micron, preferably smaller than 0.01 micron, more preferably smaller than 0.001 micron from the FCC cat fines slurry oil.

The nanofiltration membrane separates the FCC cat fines slurry oil into two individual streams, known as retentate and permeate. In operation, the pressurized FCC cat fines slurry oil enters the nanofiltration membrane where a retentate comprising Al+Si containing particles of 0.1 microns or less (i.e., a FCC cat fines-enriched stream) is retained on the retentate side of the membrane while the permeate (i.e., a FCC cat fines-enriched stream) exits the membrane on the permeate side of the membrane. The retentate contains an appreciable Al+Si content and, thus, may be recycled to a feed side of the FCC unit for further removal, for example, into a feed stream of the FCC cat fines slurry oil. During recycling, a portion of retentate may be discharged to avoid build-up of catalyst fines on the nanofiltration membrane. Instead of recycling, the retentate may be subjected to an optional second separation step, in which case, the retentate of the first nanofiltration separation process is used as feed for a second nanofiltration separation process. Further, instead of recycling or purifying the retentate, it may be also discharged in its entirety. The retentate, which has an increased Al+Si catalyst fines content as compared to the original FCC cat fines slurry oil feed, is valued based on its catalyst fines content and desired end-usage. Accordingly, the retentate may be lower than or similar in product value as that the original feed. The permeate, on the other hand, is considered as an upgraded filtered product since it contains a low Al+Si particle content as to compared to the Al+Si particle content of the original feed.

The nanofiltration membrane may include polymeric (i.e., non-porous or no pores) membranes or ceramic membranes (i.e., pores). Nanofiltration membranes consist of asymmetrical composite materials and have a molecular weight cut-off value (MWCO) ranging between 200 to 2000 gram/mole (Dalton). The nanofiltration membrane is suitably an organophilic or hydrophobic membrane, to retain any water in the FCC cat fines slurry oil to within the retentate, as well as, to prevent the water from passing into the permeate.

When ceramic nanofiltration membranes are used in accordance with the present invention, the average membrane pore size is suitably 30 nm or less, preferably at most 10 nm or less, more preferably at 5 nm or less. Ceramic nanofiltration membranes are known to comprise chemically inert, high-temperature stability, and anti-swelling properties when subjected to optimal conditions. Such membranes include narrow and well-defined pore size distribution, in comparison to polymeric membranes, which allows ceramic membranes to achieve a high degree of particulate removal at high flux levels.

Ceramic nanofiltration membranes may include, for example, titanium oxide, mesoporous titania, mesoporous gamma-alumina, mesoporous zirconia, and mesoporous silica. Ceramic nanofiltration membrane may also consist of inorganic materials (e.g., sintered metals, metal oxide and metal nitride materials) including a porous support (e.g., α-alumina), one or more layers of decreasing pore diameter, and an active or selective layer (e.g., α-alumina, zirconia, etc.) covering an internal surface of the membrane element. Commercially available ceramic nanofiltration membranes often have at least two layers including a microporous support layer and a thin selective layer.

Ceramic nanofiltration membrane typically comprise multi-tubular monolithic elements with multiple feed channels, or passageways, running through each element. Feed fluid, such as the FCC cat fines slurry oil, runs laterally along the multiple parallel feed channels at an elevated pressure. A portion of the FCC cat fines slurry oil permeates from inside the feed channels, through the porous walls and multi-tubular monolithic elements, and into ports located exterior to the elements. These ports collect and separate the permeate from the retentate.

Polymeric membranes are sometimes referred to in the art as dense membranes. An advantage of using a polymeric membrane over a ceramic membrane is that the lack of pores removes the possibility of larger particles becoming clogged or plugged in the pores of a membrane.

In preferred embodiments, the nanofiltration membrane is a polymeric membrane, more preferably a dense, cross-linked polymeric membrane. Such membranes provide nanofiltration properties including a network, or matrix, of regular, irregular, and/or random arrangement of polymer molecules for avoiding dissolution of the membrane once in contact with the slurry oil or other contaminants contained therein. Additionally, cross-linking of nanofiltration membranes provides long-term stability and longevity in more aggressive environments. It should be noted that reactions with cross-linking agents (e.g., chemical cross-linking) and/or irradiation can affect cross-linked membranes. Preferably, the membrane comprises a siloxane structure which has been cross-linked by means of irradiation as described in Intl. Pub. No. WO 1996/027430.

Examples of suitable, presently available dense, cross-linked polymeric membrane are cross-linked silicone rubber-based membranes, including, for example, cross-linked polysiloxane membranes, as described in U.S. Pat. No. 5,102,551. Typically, the polysiloxanes used contain the repeating unit —Si—O—, wherein the silicon atoms bear hydrogen or a hydrocarbon group. Preferably the repeating units are of the formula (I)

—Si(R)(R′)—O— (I)

wherein R and R′ may be the same or different and represent hydrogen or a hydrocarbon group selected from the group consisting of alkyl, aralkyl, cycloalkyl, aryl, and alkaryl. Preferably, at least one of the groups R and R′ is an alkyl group, and most preferably both groups are alkyl groups, more especially methyl groups. The alkyl group may also be a 3,3,3-trifluoropropyl group. Suitable polysiloxanes for the purpose of the present invention are (—OH or —NH₂ terminated) polydimethylsiloxanes and polyoctylmethylsiloxanes. A reactive terminal —OH or —NH₂ group of the polysiloxane may affect the cross-linking of the polysiloxanes.

Preferred polysiloxane membranes are cross-linked elastomeric polysiloxane membranes, where examples of such membranes are extensively as described in U.S. Pat. No. 5,102,551. Thus, suitable membranes are composed of a polysiloxane polymer such as previously described having a molecular weight of 550 to 150,000, preferably 550 to 4200 (prior to cross-linking), which is cross-linked with, as cross-linking agent, (i) a polyisocyanate, or (ii) a poly(carbonyl chloride) or (iii) R₄₋ₐSi(A)ₐ wherein A is —OH, —NH₂, —OR, or —OOCCR, a is 2, 3, or 4, and R is hydrogen, alkyl, aryl, cycloalkyl, alkaryl, or aralkyl. Further details regarding suitable polysiloxane membranes can be found in U.S. Pat. No. 5,102,551.

For the purpose of the present invention, the preferred polymeric nanofiltration membrane is a polydimethylsiloxane membrane, which is preferably cross-linked. Also, other rubbery polymeric nanofiltration membrane could be used. In general, rubbery membranes can be defined as membranes having a non-porous top layer of one polymer or a combination of polymers, of which at least one polymer has a glass transition temperature well below the operating temperature, i.e. the temperature at which the actual separation takes place. Yet, another group of potentially suitable non-porous membranes are superglassy polymers. An example of such a material is poly(trimethylsilylpropyne).

The polymeric nanofiltration membrane preferably comprises a top layer made of a dense membrane (“dense membrane layer”) and a base layer made of a porous supporting membrane (“porous membrane layer”). The dense membrane layer is the actual membrane which separates contaminants from the FCC cat fines slurry oil. The dense membrane layer, which is well known to one skilled in the art, has properties such that the FCC cat fines slurry oil passes through the membrane by dissolving in and diffusing through its structure. The thickness of the dense membrane layer is preferably as thin as possible. Suitably the thickness is between 1 and 15 μm, preferably between 1 and 5 μm. Contaminants cannot dissolve in the dense membrane layer because of their more complex structure and high molecular weight. The dense membrane layer can be made from a polysiloxane, in particular from poly(di-methyl siloxane) (PDMS).

The porous membrane layer (or porous substrate layer) is made of a porous material comprising pores have an average size greater than 5 nm. Other porous material may be a microporous, mesoporous, or macroporous material which is normally used for microfiltration or ultrafiltration. Suitable porous materials include PolyAcryloNitrile (PAN), PolyAmidelmide+TiO2 (PAT), PolyEtherlmide (PEI), PolyvinylideneDiFluoride (PVDF), and porous PolyTetraFluoroEthylene (PTFE), and can be of the type commonly used for ultrafiltration, nanofiltration or reverse osmosis. Poly(acrylonitrile) is especially preferred where a preferred combination according to the present invention is a poly(dimethylsiloxane)-poly(acrylonitrile) combination.

Since the porous membrane layer provides mechanical strength to the dense membrane layer, the thickness of it should be sufficient to provide as such. Typically, the thickness of the porous membrane layer ranges from 100 to 250 μm, more suitably from 20 to 150 μm. When the dense membrane layer and the porous membrane layer are combined, the polymeric nanofiltration membrane suitably has a thickness of from 0.5 to 10 μm, preferably of from 1 to 5 μm.

The polymeric nanofiltration membrane is suitably arranged so that permeate flows first through the dense membrane layer and then through the porous membrane layer. In this way, the pressure difference over the membrane pushes the dense membrane layer onto the porous membrane layer. The combination of the dense membrane layer and the porous membrane layer is often referred to as a polymeric nanofiltration composite membrane or a thin film polymeric nanofiltration composite.

The polymeric nanofiltration membrane may not include the porous membrane layer. However, in that case, it should be understood that the thickness of the dense membrane layer should be sufficient to withstand the pressures applied. For example, a thickness greater than 10 μm may then be required. However, this is not preferred, as a thick dense membrane layer can significantly limit the throughput of the membrane, thereby decreasing the amount of purified product recovered per unit of time and membrane area.

Overall, the polymeric nanofiltration membrane is a thin composite membrane arranged as tubular, hollow fiber (capillary), or spiral-wound modules. Spiral-wound modules are the most commonly used style of module and typically comprise a membrane assembly of two membrane sheets between which a permeate spacer sheet is sandwiched, and where the membrane assembly is sealed at three sides. The purpose of the permeate spacer sheet is to support the main membrane against feed pressure and carry permeate to central permeate tube. A fourth side is connected to a permeate outlet conduit such that the area between the membranes is in fluid communication with the interior of the conduit. On top of the one of the membranes, a feed spacer sheet is arranged, and the assembly feed spacer sheet is rolled up around the permeate outlet conduit to form a substantially cylindrical spirally wound membrane module. The spirally wound module is placed in a specially-made casing which includes ports for hydrocarbon mixtures and permeate.

Polymeric or ceramic nanofiltration membranes of the present embodiments may operate as cross-flow nanofiltration membranes. Cross-flow filtration is a method known to those skilled in the art where the FCC cat fines slurry oil flows parallel, or tangentially, along a feed side of the nanofiltration membrane, rather than frontally passing through the membrane.

The parallel flow of the feed, combined with turbulence created by the cross-flow velocity, continually sweeps away particles and other material that would otherwise build up on the nanofiltration membrane. In this way, cross-flow filtration creates a shearing effect on the surface of the membrane that prevents build-up of retained components and/or a potential fouling layer at the membrane surface. In the present invention, cross-flow filtration is preferred in order to prevent build-up of retained particles and/or a potential fouling layer on the membrane caused by physical or chemical interactions between the membrane and various components present in the feed.

Although continuous cross-flow nanofiltration is preferred, in some instances it may be desirable to clean the nanofiltration membrane at certain intervals for optimum performance. For example, the nanofiltration membrane may be regularly flushed at the retentate side with a suitable solvent. Such flushing operations are common in membrane filtration operations and are referred to as conventional cleaning. Moreover, other methods for removing build-up and fouling may include lowering the trans-membrane pressure at the feed side or by closing an outlet at the permeate side so that the trans-membrane pressure is significantly lowered. Additionally, backwashing applications where permeate flow is reversed or pumped backwards through the membrane, at a certain frequency, to flush membrane pores can be implemented to remove build-up and prevent fouling of the nanofiltration membranes, particularly, for ceramic nanofiltration membranes.

When using a polymeric nanofiltration membrane, the transmission of the permeate along the membrane is assumed to take place via a solution-diffusion mechanism. The Al+Si containing particles dissolve and diffuse through the nanofiltration membrane to be released and recovered from the permeate side of the membrane. All other components of the feed are retained on the retentate side of the membrane as retentate.

When using a ceramic nanofiltration membrane, separation occurs based on molecular size differences, along with solution-diffusion mechanism in some instances, so material which is smaller than the membrane pore size passes along the membrane as permeate and all other components of the feed are retained as retentate. Depending on the type of membrane module, cross-flow velocity can vary between 0.5-1 meter/second (m/s) for polymeric membranes or up to 2 m/s for ceramic membranes.

The nanofiltration membrane separation of the FCC cat fines slurry oil is suitably carried out at a temperature in the range of from 75 to 200° C. for the polymeric nanofiltration membrane or at a temperature ranging from 50 to 300° C. for the ceramic nanofiltration membrane. The trans-membrane pressure over the membrane during separation is typically in the range of from 0.1 to 40 bar, more specifically from 0.3 to 20 bar. As the permeate is substantially free of Al+Si containing particles, it is preferred to increase the pressure of the permeate rather than the pressure of the FCC cat fines. Additionally, the nanofiltration membrane may operate at a flux of between 0.5 to 180 kilogram per square meter membrane area per hour (kg/m²hr).

In the present invention, both polymeric and ceramic nanofiltration membranes are capable of retaining 80% by weight or more, preferably 90% by weight or more, more preferably 95% by weight or more, and most preferably 99% by weight or more of the Al+Si containing particles. Accordingly, the weight percentage (wt %) recovery of permeate on feed is typically between 50 and 99 wt %, preferably between 80 and 99 wt %.

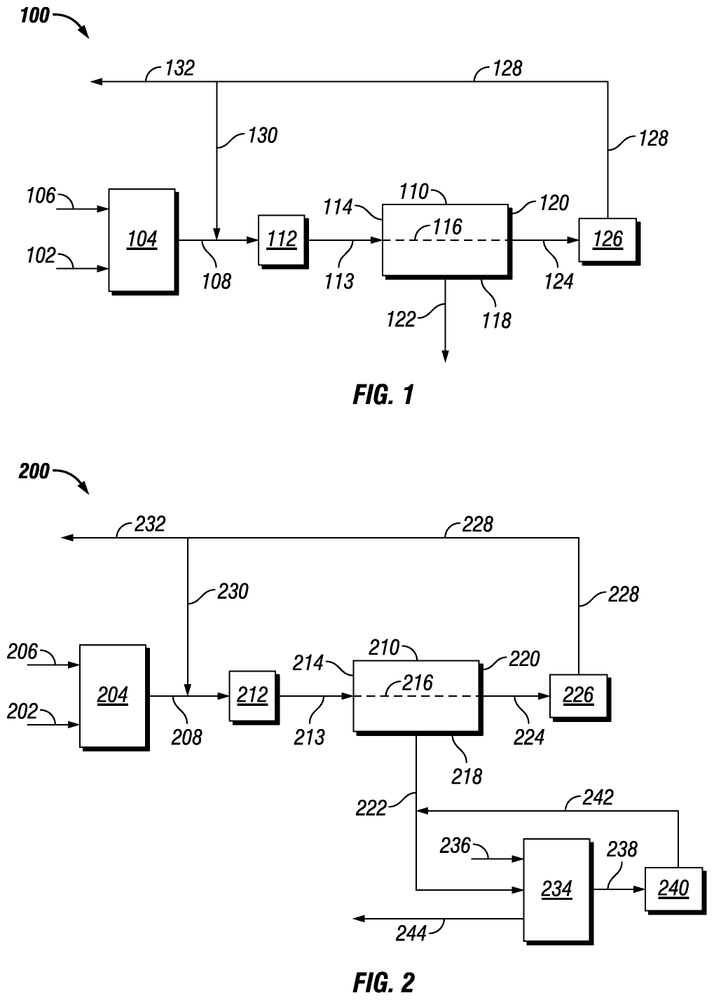

In the embodiments of the present invention, a cross-flow, nanofiltration separation unit can be used to separate and remove Al+Si containing particles of 0.1 μm or less from the FCC cat fines slurry oil. The embodiments of the process are schematically shown in FIG. 1 using a polymeric nanofiltration membrane, in FIG. 2A using a ceramic nanofiltration membrane, and in FIG. 2B using a nanofiltration membrane and a backwashing process. The feed of FIG. 1, FIG. 2A, and FIG. 2B can include either FCC clarified slurry oil or FCC slurry oil.

FIG. 1 depicts a nanofiltration membrane process in a FCC unit for removing catalyst fine particles from a hydrocarbon product. The hydrocarbon product, or feed, comprising Al+Si containing particles of 0.1 μm or less via line 102 is introduced into vessel 104. Vessel 104 is capable of heating and/or maintaining the temperature of the feed and may include, for example, a heated double walled vessel, or any other type of conventional heating element and a stirring means, such as a stirred tank or agitated vessel, for agitating the contents of the vessel. In the present embodiments, nitrogen gas via line 106 can be fed into vessel 104 to maintain and/or to elevate pressure levels.

A heated feed via line 108 exits the vessel 104 where the pressure in line 108 is typically suitable to provide the trans-membrane pressure needed for membrane separation. However, in some cases, additional compression upstream of nanofiltration unit 110 may be needed. Pump 112 includes, for example, a high-pressure feed pump or any suitable pump known to those skilled in the art that supplies sufficient pressure to feed the heated feed into nanofiltration unit 110.

The pressurized, heated feed via line 113 flows into the nanofiltration unit 110 which includes an inlet at feed side 114 for receiving the heated feed, at least one nanofiltration membrane 116, a first outlet at permeate side 118 to remove permeate from the unit, and a second outlet at retentate side 120 to remove retentate from the unit. In the present embodiments, the nanofiltration membrane 116 can include at least one polymeric nanofiltration membrane or at least one ceramic nanofiltration membrane depending on the feedstock, catalyst types, operating conditions and the desired end products. The pressurized, heated feed flows parallel to, or substantially parallel to, the at least one nanofiltration membrane 116 to be separated. The method of separation depends on the type of nanofiltration membrane incorporated into the nanofiltration unit 110. When using polymeric nanofiltration membranes, separation is based on differences in the solubility and diffusivity of Al+Si containing particles. For ceramic nanofiltration membranes, separation is based on molecular size differences where only the material which is smaller than the pore size of the nanofiltration membrane is allowed to pass. In operation, the pressurized, heated feed to be permeated dissolves and diffuses through the nanofiltration membrane 116, after which the permeate, or catalyst fines-depleted stream via line 122 is recovered at the permeate side 118. The catalyst fines-depleted stream is a liquid comprised of a reduced Al+Si particle content, as compared to the feed via line 102. In the embodiments, the catalyst fines-depleted stream via line 122 comprises an Al+Si containing particles content of 10 ppw or less, preferably 1 ppmw or less, and more preferably a non-measurable amount of Al+Si containing particles of 0.1 μm or less. Due to its reduced solid content, the catalyst fines-depleted stream via line 122 is usable as a heavy-oil end-product, for example, feedstock for carbon black production, high value fuel product, or blending stock.

Part of the pressurized, heated feed that did not permeate is recovered at the retentate side 120 as retentate, or as a catalyst fines-enriched stream via line 124. The catalyst fines-enriched stream is a liquid comprising Al+Si containing particles of 0.1 μm or less originally contained and removed from the heated feed. The catalyst fines-enriched stream via line 124 is recycled under pressure created by pump 126, such as a circulation pump, to ensure circulation of the stream across the nanofiltration membrane 116. Accordingly, a pressurized, catalyst fines-enriched stream via line 128 exits pump 126 to be thereafter split into various streams. As shown in FIG. 1, a first split stream of the catalyst fines-enriched stream via line 130 is recycled upstream of pump 112 so as to merge with heated feed via line 108. A second split stream of the catalyst fines-enriched stream via line 132 is recycled to an upstream section of the FCC unit 100 so as to merge with line 102 which comprises feed containing Al+Si containing particles of 0.1 μm or less.

FIG. 2 depicts a nanofiltration membrane process in a FCC unit for removing catalyst fine particles from a hydrocarbon product and further including a backwashing process. FIG. 2 includes all of the features of FIG. 1, but is expanded to include the backwashing process. Accordingly, with respect to FIG. 1, like numbered items are as described with respect to FIG. 2. Backwashing of a membrane refers to reversed fluid flow through the nanofiltration membrane in comparison to the normal flow direction required for permeate production. Backwashing is often implemented to remove particulate matter, such as catalyst fines, from a membrane surface and to reduce or prevent fouling. In the present embodiments, permeate is used for temporary reversed fluid flow, however, other fluids (e.g., water, oil, air, etc.) may be used. As shown in FIG. 2, the catalyst fines-depleted stream via line 222 exits the nanofiltration membrane 210 and flows into an intermediate permeate storage vessel 234 where it is heated, stirred and blanketed with nitrogen via line 236. A heated, clean permeate via line 238 exits vessel 234 and flows into backwash pump 240 at a certain frequency, such as 1 to 6 times per hour, while pump 212 is shut-off for a period of time, e.g., 10-30 seconds. The backwash pump 240 pumps pressurized clean permeate via line 242 to the permeate side 218 so as to merge with the catalyst fines-depleted stream via line 222. Accordingly, in the present embodiments, the catalyst fines-depleted stream via line 222 acts as a reversed fluid flow to backwash the nanofiltration membrane 216 while a waste concentrate stream via line 244 is concurrently produced by the intermittent backwash process. After the expiration of the period of time, backwash pump 240 is shut off to discontinue permeate reversed fluid flow while feed pump 212 is simultaneously re-started to resume normal flow direction required for permeate production.

The process of removing Al+Si particles of 0.1 μm or less from a FCC cat fines slurry oil fulfills the continuing need for a nanofiltration process that upgrades the oil by reducing the total concentration of Al+Si particles in the permeate to 10 ppmw or less, to 1 ppmw or less, or preferably, to a non-measurable amount. Such removal converts low-value FCC slurry oil into a higher value, quality product. The use of a higher value product, as compared to the low-value FCC slurry oil, reduces wear and damage of process machinery and equipment, slurry oil tank cleaning costs and maintenance downtime, and concerns related to hazardous waste in catalyst-containing tank sediments, among other benefits.

### EXAMPLES

The invention will be further illustrated in more detail by the following examples where nanofiltration membrane tests were carried out as schematically shown in either FIG. 1 for polymeric nanofiltration membranes or FIG. 2 for ceramic nanofiltration membranes. In all examples, the feed is a clarified FCC slurry oil since conventional technologies were initially applied to remove Al+Si containing particles larger than 0.1 μm. Accordingly, feed provided for Example 1-3 include catalyst fines comprised of Al+Si containing particles of 0.1 μm or less.

### Example 1

Example 1 presents the results of nanofiltration membrane testing of a clarified FCC slurry oil comprising a kinetic viscosity of 18.6 centistokes (cSt) at 100° C. Three separate tests using three different nanofiltration membranes were carried out at various temperatures to remove catalyst fines comprised of Al+Si containing particles 0.1 μm or less from the clarified FCC slurry oil. The first and second tests were carried out using ceramic (titanium dioxide (TiO₂)) nanofiltration membranes while the third test was carried out using a polymeric nanofiltration membrane. In addition to the membrane type, the test conditions for each test are shown in Table 1. In particular, test conditions including temperature, trans-membrane pressure (TMP), and the respective concentrations of Al and Si in the feed for each test of Example 1 are provided in Table 1.

TABLE 1
Membrane Type and Test Conditions for Example 1

| | Membrane | Temp, | TMP, | Al content, | Si content, |
|---|---|---|---|---|---|
| Test | Type | ° C. | bar | ppmw | ppmw |
| 1 | Ceramic | 75 | 0.3-0.5 | 40 | 60 |
| | (TiO₂), | | | | |
| | 30 nm | | | | |
| 2 | Ceramic | 75 | 1-10 | 40 | 60 |
| | (TiO₂), | | | | |
| | 5 nm | | | | |
| 3 | Polymeric | 90 | 15 | 40 | 60 |

Table 2 provides nanofiltration membrane test results after the removal of Al+Si containing particles 0.1 μm or less from the clarified FCC slurry oil for each test of Example 1.

TABLE 2
NanoBitration Membrane Test Results for Example 1

| | | | Permeate | | | Al content | | | Si content | | |
|---|---|---|---|---|---|---|---|---|---|---|---|
| | Flux | Permeability | Yield | Mass split, | | ppmw | | | ppmw | | |
| Test | kg/(m² · hr) | kg/(m² · hr · bar) | % wt. | grams | | Feed | Permeate | Retentate | Feed | Permeate | Retentate |
| 1 | 5-6 | 12-14 | 56.2 | Feed | 428 | 40 | <0.5 | 30 | 60 | 10 | 50 |
| | | | | Permeate | 241 | | | | | | |
| | | | | Retentate | 126 | | | | | | |
| | | | | Loss | 61 | | | | | | |
| 2 | 2 | 2 | 51.2 | Feed | 428 | 40 | <0.5 | 310 | 60 | <1 | 300 |
| | | | | Permeate | 215 | | | | | | |
| | | | | Retentate | 200 | | | | | | |
| | | | | Loss | 13 | | | | | | |
| 3 | 0.6 | 0.04 | 67.8 | Feed | 218 | 40 | <0.5 | 80 | 60 | 20 | 110 |
| | | | | Permeate | 148 | | | | | | |
| | | | | Retentate | 48 | | | | | | |
| | | | | Loss | 22 | | | | | | |

The mass of the permeate is recorded against time to provide a permeate flow rate (g/hr). Based on the permeate flow rate and the surface area of the nanofiltration membrane, the flux rate kg/(m²·hr) was calculated, where the flux rate includes the quantity of permeate produced during nanofiltration per unit of time and membrane area. The permeability kg/(m²·hr·bar) is subsequently calculated by dividing the flux rate by the trans-membrane pressure. The permeate yield as calculated includes the fraction of feed that is converted to permeate, which is expressed as a percentage by mass, or weight percentage (wt %). Accordingly, the calculated values for flux rate, permeability, and permeate yield for Example 1 are shown in Table 2. Additionally, the mass fraction of feed, permeate, retentate and loss of material in the nanofiltration experiment, along with the concentration of Al+Si containing particles of 0.1 μm or less in both the original feed, permeate, and retentate are provided in Table 2.

Test 1 of Example 1 was conducted using a ceramic nanofiltration membrane comprising 30 nm pores and at a temperature of 75° C. for a run time of about 24 hours. Ceramic membranes are well-known for being sensitive towards fouling, especially if solids are present in the feed. To prevent solids from moving towards the surface of the ceramic membrane, or ingress of solids into the pores of the membrane, a low TMP ranging from 0.3 to 0.5 bar was established to provide a low flux. During Test 1, the permeability at TMP of 0.5 bar decreased until TMP of 0.3 bar is reached. Upon pressurizing the process up to 0.5 bar, the permeability decreased again, thus, indicating limited fouling behavior.

Test 2 of Example 1 was conducted using a ceramic nanofiltration membrane comprising 5 nm pores and at a temperature of 75° C. 2 for a run time of about 52 hours. Such smaller pores are generally less sensitive to ingress of solids, and therefore, various TMP levels (i.e., 1, 5, 10 bar) at a constant temperature of 75° C. were carried out during Test 2. After an initial period at 1 bar TMP, the TMP was increased to 5 bar and thereafter to 10 bar. With both pressure increases, there was a slight increase in flux and a decrease in permeability. This effect seemed reversible as the permeability returned approximately to its original level, thus, indicating limited fouling behavior.

Test 3 of Example 1 was conducted using a polymeric nanofiltration membrane for a run time of about 32 hours. The temperature was raised to 90° C. with an applied TMP of 15 bar since permeability is relatively low and the occurrence of potential fouling issues reduced when using a polymeric membrane. During Test 3, the permeability and flux remained low and relatively constant compared to the ceramic nanofiltration membranes used in Tests 1 and 2. Such results indicate that permeability is mostly independent of the applied TMP, and thus, there was little to no fouling issues during separation using the polymeric nanofiltration membrane.

The Al and Si content in the permeates for each test of Example 1 showed a much lower particle content than in the initial feed after separation by nanofiltration. In particular, the Al concentration in the permeate after each test is substantially free or free of Al particles 0.1 μm or less since the Al particle content is below the detection limit of 0.5 ppmw. Similarly, the Si concentration in the permeate after Test 2 is substantially free or free of Si particles 0.1 μm or less since the Si particle content is lower than 1 ppm. In Tests 1 and 3, the Si particle content in the permeate is 10 ppmw and 20 ppmw, respectively, and thus, is lower than in the initial feed. These values may be attributed to silicon anti-foaming agents used to remove foam generated during testing. Based on the results provided, Example 1 describes enhanced filtration efficiency at reasonable flux values since the permeate yield, containing particle of 0.1 microns or less, is greater than 50% based on the weight percentage of the feed for each test.

### Example 2

Example 2 presents the results of nanofiltration membrane testing of a clarified FCC slurry oil comprising a kinetic viscosity of 11.4 centistokes (cSt) at 100° C. Three separate tests were carried out using ceramic (TiO₂) nanofiltration membranes with pore size of 30 nm to remove catalyst fines comprised of Al+Si containing particles 0.1 μm or less from a clarified FCC slurry oil. In addition to the membrane type, the test conditions for each test are shown in Table 3. The first and second tests were performed at a temperature of 75° C. while the third test was carried out at 125° C. In addition to temperatures, other test conditions including trans-membrane pressure (TMP) and the respective concentrations of Al and Si in the feed for each test of Example 2 are provided in Table 3.

TABLE 3
Membrane Type and Test Conditions for Example 2

| | Membrane | Temp, | TMP, | Al content, | Si content, |
|---|---|---|---|---|---|
| Test | Type | ° C. | bar | ppmw | ppmw |
| 1 | Ceramic | 75 | 5-10 | 17.3 | 14.9 |
| | (TiO₂), | | | | |
| | 30 nm | | | | |
| 2 | Ceramic | 75 | 10-14 | 17.3 | 14.9 |
| | (TiO₂), | | | | |
| | 30 nm | | | | |
| 3 | Ceramic | 125 | 10 | 17.3 | 14.9 |
| | (TiO₂), | | | | |
| | 30 nm | | | | |

Table 4 provide nanofiltration membrane test results after the removal of Al+Si containing particles 0.1 μm or less from the clarified FCC slurry oil for each test of Example 2. As previously described with respect to Table 2, the flux, permeability, permeate yield and various mass fractions for each test of Example 2 is provided in Table 4.

TABLE 4
NanoBitration Membrane Test Results for Example 2

| | | | Permeate | | | Al content | | | Si content | | |
|---|---|---|---|---|---|---|---|---|---|---|---|
| | Flux | Permeability | Yield | Mass split, | | ppmw | | | ppmw | | |
| Test | kg/(m² · hr) | kg/(m² · hr · bar) | % wt. | grams | | Feed | Permeate | Retentate | Feed | Permeate | Retentate |
| 1 | 20 | 2 | 83 | Feed | 592 | 17.3 | Non- | Non- | 14.9 | Non- | Non- |
| | | | | | | | measurable | measurable | | measurable | measurable |
| | | | | Permeate | 492 | | | | | | |
| | | | | Retentate | 28 | | | | | | |
| | | | | Loss | 72 | | | | | | |
| 2 | 28 | 2.8 | 59.8 | Feed | 502 | 17.3 | <0.5 | 38.8 | 14.9 | 0.5 | 33.2 |
| | | | | Permeate | 300 | | | | | | |
| | | | | Retentate | 206 | | | | | | |
| | | | | Loss | −4 | | | | | | |
| 3 | 170 | 17 | 85 | Feed | 397 | 17.3 | <0.5 | 37.7 | 14.9 | 0.6 | 24.1 |
| | | | | Permeate | 337 | | | | | | |
| | | | | Retentate | 30 | | | | | | |
| | | | | Loss | 30 | | | | | | |

Test 1 of Example 2 was conducted using a ceramic nanofiltration membrane comprising 30 nm pores and at a temperature of 75° C. for a run time of about 30 hours. Since the Al+Si content is lower, as compared to the tests of Example 1, a higher TMP of 10 bar was initially applied. After lowering the TMP to 5 bar, the flux decreased yet the permeability remained constant, thus, indicating little to no fouling issues.

Test 2 of Example 2 was conducted using a ceramic nanofiltration membrane comprising 30 nm pores and at a temperature of 75° C. for a run time of about 8 hours. After applying an initial TMP of 10 bar, the TMP was increased to 14 bar. The flux responded proportionally to the increased TMP while the permeability remained relatively constant. This would indicate that the permeability is mostly independent of the applied TMPs, and thus, there was little to no fouling issues experienced during Test 2.

Test 3 of Example 2 was conducted using a ceramic nanofiltration membrane comprising 30 nm pores and at a temperature of 125° C. Due to higher temperatures, the flux and permeability showed higher values as compared to those values in Tests 1 and 2. However, the permeability was not pressure dependent and thus, there was little to no fouling experienced during Test 3. Due to the higher flux values at a TMP of 10 Bar, Test 3 was conducted for a run time of about 3 hours.

The Al and Si content for permeates for each test shows a much lower particle content than in the initial feed after separation by nanofiltration. In particular, the Al content and the Si content in the permeate after each test is substantially free or free of Al particles and Si particles, respectively, where particles of size 0.1 μm or less are either below the detection limit of 0.5 ppmw or are non-measurable. Based on the results provided, Example 2 describes enhanced filtration efficiency at reasonable flux values since the permeate yield is greater than 50% based on the weight percentage of the feed for each test.

### Example 3

Example 3 presents the results of nanofiltration membrane testing of a clarified FCC slurry oil comprising a kinetic viscosity of 4.09 centistokes (cSt) at 100° C. Two separate tests using ceramic (TiO₂) nanofiltration membranes with pore size of 30 nm were carried out to remove catalyst fines comprised of Al+Si containing particles 0.1 μm or less from a clarified FCC slurry oil. In addition to the membrane type, the test conditions for each test are shown in Table 5. The first and second tests were performed at a temperature of 75° C. and at 125° C., respectively. In addition to temperatures, other test conditions including trans-membrane pressure (TMP) and the respective concentrations of Al and Si in the feed for each test of Example 3 are provided in Table 5.

TABLE 5
Membrane Type and Test Conditions for Example 3

| | Membrane | Temp, | TMP, | Al content, | Si content, |
|---|---|---|---|---|---|
| Test | Type | ° C. | bar | ppmw | ppmw |
| 1 | Ceramic | 75 | 0.5-2 | 28.1 | 37.8 |
| | (TiO₂), | | | | |
| | 30 nm | | | | |
| 2 | Ceramic | 125 | 1-4 | 28.1 | 37.8 |
| | (TiO₂), | | | | |
| | 30 nm | | | | |

Table 6 provides nanofiltration membrane test results after the removal of Al+Si containing particles 0.1 μm or less from the clarified FCC slurry oil for each test of Example 3. As previously described with respect to Table 2, the flux, permeability, permeate yield and various mass fractions for each test of Example 3 is provided in Table 6.

TABLE 6
Nanofiltration Membrane Test Results for Example 3

| | | | Permeate | | | Al content | | | Si content | | |
|---|---|---|---|---|---|---|---|---|---|---|---|
| | Flux | Permeability | Yield | Mass split, | | ppmw | | | ppmw | | |
| Test | kg/(m² · hr) | kg/(m² · hr · bar) | % wt. | grams | | Feed | Permeate | Retentate | Feed | Permeate | Retentate |
| 1 | 7 | 14 | 62.9 | Feed | 814 | 28.1 | <0.5 | 182 | 31.8 | <0.5 | 196 |
| | | | | Permeate | 512 | | | | | | |
| | | | | Retentate | 334 | | | | | | |
| | | | | Loss | −22 | | | | | | |
| 2 | 120 | 30 | 67.5 | Feed | 812 | 28.1 | <0.5 | 93.5 | 31.8 | 1.4 | 103 |
| | | | | Permeate | 548 | | | | | | |
| | | | | Retentate | 238 | | | | | | |
| | | | | Loss | 26 | | | | | | |

Test 1 of Example 3 was conducted using a ceramic nanofiltration membrane comprising 30 nm pores and at a temperature of 75° C. for a run time of about 24 hours. Based on the Al+Si content, an initial TMP of 1 bar was initially applied. The permeability increased when the TMP decreased from 1 bar to 0.5 bar but decreased when the TMP was increased to 2 bar. Such pressure dependent behavior related to the permeability was indicative of the presence of solids in the test samples, thus, causing some error in the analysis and limited fouling behavior.

Test 2 of Example 3 was conducted using a ceramic nanofiltration membrane comprising 30 nm pores and at a temperature of 125° C. for a run time of about 8 hours. At TMP of 1 bar, flux and permeability remain relatively constant. When the TMP was increased to 4 bar, flux increased but not at a proportional rate so that permeability decreased. Such pressure dependent behavior related to the permeability was indicative of the presence of solids in the test samples, thus, causing some error in the analysis and limited fouling behavior.

The Al and Si content for permeates for each test shows a much lower particle content than in the initial feed after separation by nanofiltration. In particular, the Al content and the Si content in the permeate after Test 1 is substantially free or free of Al particles and Si particles, respectively, where particles 0.1 μm or less are below the detection limit of 0.5 ppmw. For Test 2, the Al content in the permeate is substantially free or free of Al particles 0.1 μm or less where the detection limit is below 0.5 ppmw. The Si content for the permeate concentration of Test 2 is 1.4 ppmw but is well below the initial Si content of 31.8 ppmw in the initial feed. As previously stated, this may be indicative of solids in the test samples, thus, causing some error during analysis. Overall, Example 3 describes enhanced filtration efficiency at reasonable flux values since the permeate yield is greater than 50% based on the weight percentage of the feed for each test.

In Examples 1-3, the Al+Si concentration in the feed, permeates, and retentates have been measured by inductively coupled plasma (ICP) spectrometry after nanofiltration. The results as provided for in Tables 2, 4, and 6, show that the quality of the permeate is significantly improved as compared to the quality of the feed due to reduced Al+Si particle content or essentially zero Al+Si particle content, which is non-measurable with fit-for-purpose analytical techniques. Based on these results, the present invention provides that nanofiltration membranes can be used to remove Al+Si containing particles of 0.1 μm or less from a FCC slurry oil or a clarified FCC slurry oil.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

That which is claimed is:

1. A process for removing catalyst fine particles from a hydrocarbon product, the process comprising:
providing at least one nanofiltration membrane to remove the catalyst fine particles from the hydrocarbon product, the catalyst fine particles comprising a particle size of 0.1 microns or less;
contacting the hydrocarbon product at a feed side of the nanofiltration membrane;
recovering a catalyst fines-depleted stream at a permeate side of the nanofiltration membrane;
recovering a catalyst fines-enriched stream at a retentate side of the nanofiltration membrane; and
wherein the catalyst fines-enriched stream comprises the catalyst fine particles removed from the hydrocarbon product, the catalyst fine particles comprising a particle size of 0.1 microns or less.

2. The process of claim 1, wherein the hydrocarbon product contains at least 30 ppmw of the catalyst fine particles.

3. The process of claim 1, wherein the catalyst fine particles comprise aluminum and silicon (Al+Si) containing particles.

4. The process of claim 1, wherein the catalyst fines-depleted stream contains 10 ppmw or less of the Al+Si containing particles, 1 ppmw or less of the Al+Si containing particles, or a non-measurable amount of the Al+Si containing particles.

5. The process of claim 1, wherein the catalyst fines-depleted stream is usable as an end-product.

6. The process of claim 1, further comprising recycling at least a portion of the catalyst-enriched stream into a feed stream of a FCC unit.

7. The process of claim 1, wherein the nanofiltration membrane comprises a polymeric nanofiltration membrane or a ceramic nanofiltration membrane having a maximum average pore size of 50 nm.

8. A membrane separation unit for use in a catalytic cracking unit, the membrane separation unit comprising:
at least one nanofiltration membrane to remove catalyst fine particles from a hydrocarbon product, the catalyst fine particles comprising a particle size of 0.1 microns or less;
a feed side of the nanofiltration membrane for contacting the hydrocarbon product;
a permeate side of the nanofiltration membrane for recovering a catalyst fines-depleted stream;
a retentate side of the nanofiltration membrane for recovering a catalyst fines-enriched stream; and
wherein the catalyst fines-enriched stream comprises the catalyst fine particles removed from the hydrocarbon product, the catalyst fine particles comprising a particle size of 0.1 microns or less.

9. The membrane separation unit of claim 11, wherein the catalyst fine particles comprise aluminum and silicon (Al+Si) containing particles.

10. The membrane separation unit of claim 11, wherein the catalyst fines-depleted stream contains 10 ppmw or less of Al+Si containing particles, 1 ppmw or less of Al+Si containing particles, or a non-measurable amount of the Al+Si containing particle.
